(19) United States
(12) Patent Application Publication
(10) Pub. No.: US 2026/0160124 A1
(43) Pub. Date: Jun. 11, 2026

(54) RETRACTABLE ROLLING PRIVACY PANEL FOR PUBLIC RESTROOM STALLS

(71) Applicant: Béla Debitzky, Miami, FL (US)

(72) Inventor: Béla Debitzky, Miami, FL (US)

(21) Appl. No.: 19/405,563

(22) Filed: Dec. 2, 2025

Related U.S. Application Data
(60) Provisional application No. 63/729,062, filed on Dec. 6, 2024.

(51) Int. Cl. E06B 9/24

(52) U.S. Cl. CPC E06B 9/24

(57) ABSTRACT

A closure system for public restroom stalls includes a retractable and extendable privacy panel formed of a flexible material that is wound on a spring-loaded roller contained within a housing. A housing is mounted to the inside of the existing stall partition as a retrofit using existing holes that were previously used for door hardware. The flexible privacy panel is pulled from the housing against the spring-loaded retracting force of the roller and across the entry of the stall under moderate tension, and is latched onto a knob or other mechanism in a manner that leaves no gaps on the sides of the flexible privacy panel. The flexible privacy panel may be formed of a screen, canvas, flexible plastic or other flexible material that is opaque to provide complete privacy.

### BACKGROUND OF THE INVENTION

This non-provisional patent application is based on provisional patent application Ser. No. 63/729,062 filed on Dec. 6, 2024.

### FIELD OF THE INVENTION

The present invention relates to closure systems for door entries and, more particularly, to a closure system for a public restroom stall including a retractable and extendable flexible privacy panel that is pulled against a spring-loaded force to close the entry of a public restroom stall without impeding any space within the restroom stall.

### DESCRIPTION OF THE RELATED ART

Currently, public restroom stalls have doors that are hinged to swing into the stall space. Many times, the doors are mis-aligned and there are gaps that prevent complete privacy. Also, it is difficult for a person looking to use a stall to readily know which stalls are occupied. At airports, where people often have luggage with them, it is difficult for a person to maneuver around the inwardly swinging door with their luggage, as the space inside the stall is limited.

### SUMMARY OF THE INVENTION

The present invention seeks to overcome the problems and shortcomings of existing public restroom stall doors. The solution provided by the present invention is a retractable privacy screen or flexible panel that is pulled and extended from a spring-loaded roller contained in a housing. The device would be mounted on the inside of existing stall partition as a retrofit using existing holes for door hardware that would be removed. To close the stall entry to allow the occupant to use the toilet in complete privacy, the screen or flexible panel is pulled across the stall entry under moderate tension and is latched on a knob or other mechanism on the opposite side of the entry. The present invention solves at least four significant problems that currently exist:
1. Unoccupied stalls are quickly visible when fitted with the retractable privacy panel that replaces the convention swinging door.
2. Door swing is eliminated so that access in and out of the stall, with or without luggage, is much easier.
3. More privacy. With no gaps like traditional stall doors, there is no need to worry that someone could peek in.
4. More secure locking. Currently if the swing stall door or post is mis-aligned, the closing mechanism doesn't lock properly. With the flexibility of the fabric of the privacy panel of the present invention, that issue is eliminated.

### BRIEF DESCRIPTION OF THE DRAWINGS

For a fuller understanding of the nature of the present invention, reference should be had to the accompanying drawings in which:

FIG. 1 is a top plan view illustrating adjacent public restroom stalls and showing a comparison of the conventional swinging door on one stall and the retractable rolling privacy panel of the present invention installed on the adjacent stall, and demonstrating the unimpeded space in the stall using the privacy panel of the present invention;

FIG. 2 is an elevational view taken along the plane indicated by the arrows 2-2 in FIG. 1 of the interior of the adjacent public restroom stalls showing the retractable rolling privacy panel of the present invention in a retracted position to allow access in and out of the stall, and further showing the conventional door closed on the adjacent stall that leaves open gaps on each side of the door that present privacy concerns;

FIG. 3 is a cross sectional view taken along the plane indicated by the arrows 3-3 in FIG. 2; and

FIG. 4 is an isolated elevational view showing movement of the retractable rolling privacy panel system of the present invention across the stall entry opening, wherein the flexible privacy panel can be latched and secured in a closed position to completely close the entry opening with no open gaps, thereby providing complete privacy while using the stall, and further wherein the flexible privacy panel is retractable within the housing on the opposite side of the entry opening of the stall within the housing, as shown in FIGS. 2 and 3 so that it is readily visible that the stall is unoccupied.

Like reference numerals refer to like parts throughout the several views of the drawings.

### DETAILED DESCRIPTION OF THE PREFERRED EMBODIMENT

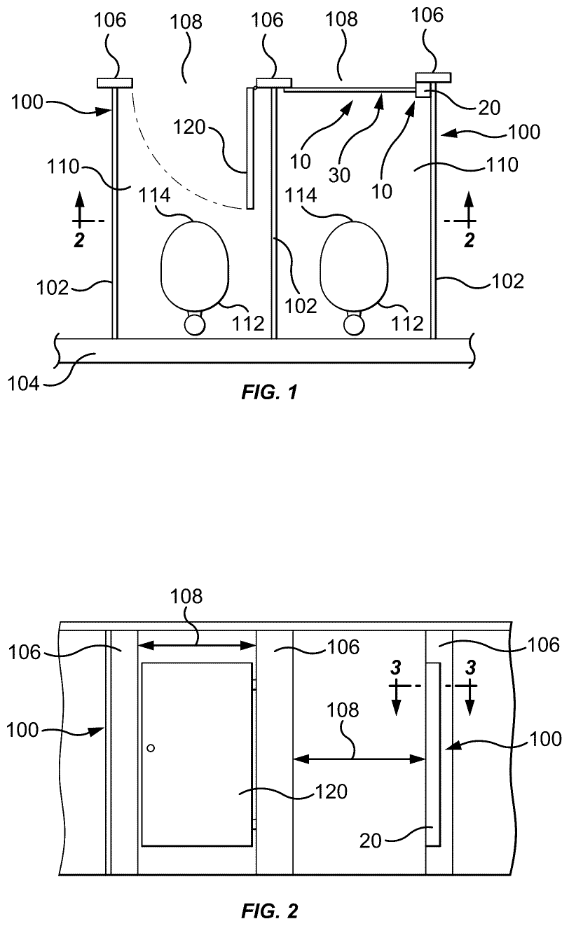

Referring to the several views of the drawings, the public restroom stall closure system is shown and is generally indicated as 10. As seen in FIGS. 1 and 2, adjacent public restroom stalls 100 include rigid side walls 102 providing dividers between adjacent stalls and an end side wall at the last stall. Each public restroom stall further includes a solid back wall 104 that is typically the solid building structure wall, such as a cement wall that is covered with tile. The public restroom stalls 100 further include rigid front panels 106 forming a partial front wall with an entry opening 108 between adjacent front panels 106; the entry opening 108 thereby allowing entry into the interior of a stall, as well as exit from the stall. As seen in FIG. 1, the adjacent public restroom stalls 100 share a common rigid side wall 102, forming a divider to separate the stalls.

FIGS. 1 and 2 further illustrate a comparison of a conventional stall door 120 that hinges open and closed, as indicated by the broken lines in FIG. 1, and the adjacent stall being fitted with the closure system of the present invention including the retractable privacy panel 30. Each stall has a space measured between a front end 114 of the toilet 112 and the entry 108, this area being designated as 110 and serving as an area for the user of the stall to enter and maneuver within the stall as needed. As seen in FIG. 1, the conventional stall door 120 swings through this interior stall space 110 between the front 114 of the toilet 112 and the entry 108, significantly impeding the user's ability to maneuver, especially when bringing luggage into the stall, such as in an airport restroom. In comparison, it is seen in FIG. 1, the retractable privacy panel 30 leaves the interior space 110 unimpeded between the front 114 of the toilet 112 and the entry to the stall 108, thereby allowing the user to maneuver unimpeded within that interior space 110 when entering the stall, when closing and opening the privacy panel 30 across the entry 108, as well as when leaving the stall.

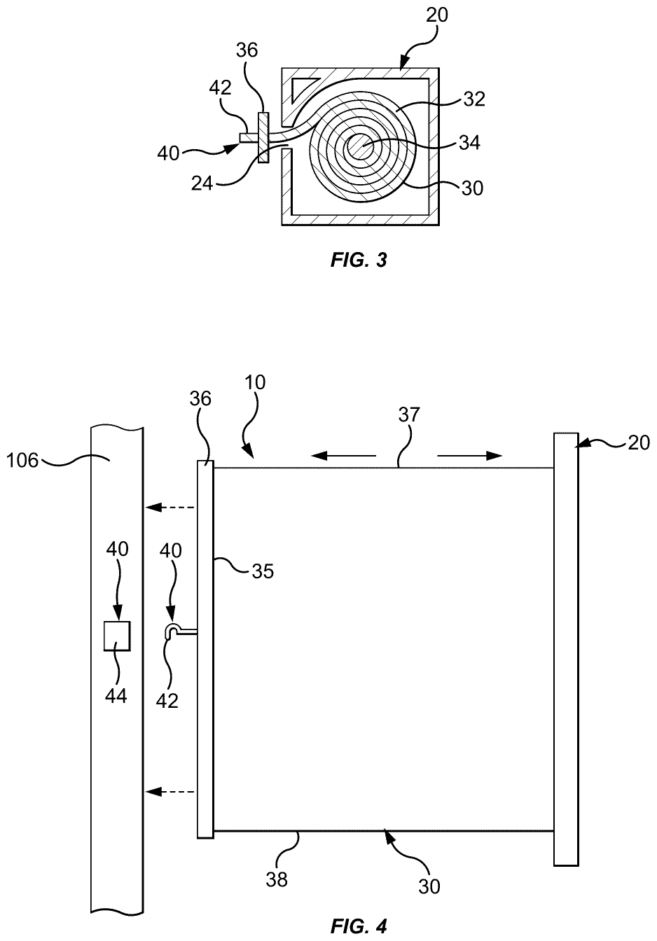

The public restroom stall closure system 10 of the present invention includes a privacy panel housing 20 that mounts to the interior wall structure of the stall, and particularly at the juncture between one of the side walls 102 and the rigid front panel 106, as seen in FIGS. 1 and 2. Referring to FIG. 3, it is seen that the privacy panel 30 is retractable into a roll form 32 about a central spring-loaded roller 34 that extends vertically within the center of the housing 20. The spring-loaded roller allows the flexible panel to be wound up into the roll configuration 32, and then to be pulled out through a vertical opening 24 on a side of the housing 20 against the spring-loaded force of the roller 34 and pulled across the stall entry 108, as shown in FIG. 4. The end of the privacy panel 30 is fitted with an elongated rigid member 36, such as a batten, which helps to maintain the shape of the privacy panel, holding the privacy panel 30 taut, particularly between a top edge 37 and a bottom edge 38. The elongated rigid member 36 further serves as a stop member to prevent the side edge 35 of the privacy panel 30 from being pulled entirely into the interior of the housing 20. This allows the user to easily grasp the elongated rigid member 36, or a closure mechanism 40 fixed to the elongated rigid member 36, in order to pull the flexible privacy panel across the stall entry opening 108 so that the latch mechanism 40 can be secured. In one embodiment, the latch mechanism 40 may include a first latch member 42 that releasably attaches in interlocked relationship with a second latch member 44 that is mounted to the inside face of the front panel 106. As seen in FIG. 1, when the flexible privacy panel 30 is pulled across the entry opening 108, there is no gap between the rigid front panels 106 on either side of the entry opening and the flexible privacy panel 30, thereby providing complete privacy and preventing someone from peaking into the stall when the stall is in use.

The flexible privacy panel 30 is preferably formed of a durable, flexible material that is easily cleaned and does not hold bacteria or other germs. Specifically, the material of the flexible privacy panel 30 preferably has a smooth inner and outer surface that is easily wiped clean to remove all germs and bacteria during regular cleaning and maintenance of the public restroom.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A closure system for a public restroom stall comprising:
rigid front panels extending vertically on opposite sides of an entry to the restroom stall including a first rigid front panel on one side of the entry and a second rigid front panel on the opposite side of the entry;
a roller housing structured for attachment to the first rigid front panel and including an elongated vertical opening on one side of the housing;
a spring-loaded roller vertically supported within an interior of the housing;
a flexible privacy panel having one end attached to the spring-loaded roller and an opposite second end maintained exteriorly of the elongated opening on the housing, and the privacy panel maintained in a roll form around the spring-loaded roller within the housing and the privacy panel being structured and disposed to be pulled outwardly from the housing to at least partially unwind the roll form and extend across the entry of the restroom stall to close the entry with no open gaps between the privacy panel and the first rigid front panel and the second rigid front panel; and
a latch mechanism for releasably securing the second end of the privacy panel to the second rigid front panel to maintain the privacy panel in the operative closed position across the entry of the restroom stall.

2. The closure system as recited in claim 1 wherein the privacy panel is formed of a flexible material that is opaque and not see-through.

3. The closure system as recited in claim 2 wherein the privacy panel is formed of a screen material.

4. The closure system as recited in claim 2 wherein the privacy panel is formed of a canvas material.

5. The closure system as recited in claim 2 wherein the privacy panel is formed of a flexible plastic material.

6. The closure system as recited in claim 2 further comprising:
an elongated rigid batten fixed to the second end of the privacy panel for maintaining the privacy panel taut between a top edge and a bottom edge when the privacy panel is pulled outwardly from the housing and retracted back into the housing, and further wherein the privacy panel is maintained taut when secured by the latch mechanism to the second rigid front panel.
